(19) United States
(12) Patent Application Publication
(10) Pub. No.: US 2007/0052245 A1
(43) Pub. Date: Mar. 8, 2007

(54) Depressible snap finger for a deadbolt assembly

(75) Inventors: Jerry B. Bodily, Colorado Springs, CO (US); Justin Lotak, Chicago, IL (US); Brian K. Roth, Elbert, CO (US); Shivanand Shivalli, Colorado Springs, CO (US); James D. Ohl, Colorado Springs, CO (US)

Correspondence Address: MICHAEL BEST & FRIEDRICH, LLP, 100 E WISCONSIN AVENUE, MILWAUKEE, WI, 53202, US

(73) Assignee: Schlage Lock Company, Carmel, IN (US)

(21) Appl. No.: 11/367,966

(22) Filed: Mar. 3, 2006

Related U.S. Application Data
(60) Provisional application No. 60/715,216, filed on Sep. 8, 2005.

(51) Int. Cl. E05C 1/00

(52) U.S. Cl. 292/1.5; 292/337

(57) ABSTRACT

An adjustable backset deadbolt assembly providing operational and structural improvements. The deadbolt assembly can provide adjustability between a first backset dimension and a second backset dimension for allowing installation in doors conforming to various industry standards. The deadbolt assembly can provide adjustability between backset dimensions by relative rotation between the inner bolt housing and the outer housing. The inner bolt housing may be provided with a depressible snap finger to allow insertion of a protrusion thereon into a slot in the outer housing. In some embodiments, the slot is provided substantially helically through an angle of 360 degrees to provide common orientation of parts in each backset dimension. The outer housing may be provided to integrally form a cam housing and a bolt housing.

### REFERENCE TO RELATED APPLICATIONS

This application claims the benefit of U.S. Provisional Patent Application Ser. No. 60/715,216 filed on Sep. 8, 2005, the entire contents of which is incorporated by reference.

### BACKGROUND

The present invention relates to locking mechanisms, and more particularly to deadbolt assemblies adjustable for different backset dimensions.

Deadbolts have long been known to prevent unwanted access through doors and the like. Typically, a deadbolt is installed in a door with a bolt, which is extendable from the edge of the door and engages an adjacent wall when extended. An actuator is generally provided on one side of the door to allow an operator to move the bolt between extended and retracted positions. The actuator is generally rotatable about an axis perpendicular to the door and is spaced from the edge by a distance commonly referred to as the backset. Backset dimension can vary among applications, but two industry standard values are 2⅜ inches and 2¾ inches. Rather than develop and produce separate deadbolt assemblies for the different backset dimensions, it is advantageous not only for the manufacturer, but also the consumer, to provide a deadbolt assembly, which is adjustable and therefore capable of being used with either a 2⅜ inch backset or a 2¾ backset.

### SUMMARY

In one embodiment, the invention provides an adjustable backset deadbolt assembly including a bolt extendable and retractable along a bolt axis in response to movement of a cam and a bolt bar. The assembly includes an outer housing with a slot. An inner housing is fixed against rotation relative to the bolt and includes a protrusion that extends radially from a depressible portion of the inner housing and is positioned to engage the slot to enable adjustment of a backset dimension.

In another embodiment the invention provides an adjustable backset deadbolt assembly including a bolt extendable and retractable along a bolt axis in response to movement of a cam and a bolt bar. The assembly includes a first housing and a second housing. One of the first housing and the second housing includes a slot and the other of the first housing and the second housing includes a protrusion extending from a depressible portion. The depressible portion is depressible to enable insertion of the protrusion into the slot. A backset dimension is adjustable by movement of the protrusion in the slot.

In another embodiment the invention provides an adjustable backset deadbolt assembly including a bolt extendable and retractable along a bolt axis in response to movement of a cam and a bolt bar. The bolt has a connector engageable with a slot in the bolt bar to enable the bolt to be rotatable relative to the bolt bar to adjust a backset dimension between a first predetermined value and a second predetermined value. The assembly includes an outer housing including a slot. An inner housing is fixed against rotation relative to the bolt and includes a protrusion extending radially from a depressible portion of the inner housing and positioned to engage the slot to enable adjustment of the backset dimension. The depressible portion is formed by a U-shaped groove cut through an entire wall thickness of the inner housing. The protrusion is positioned about one third the length of the depressible portion away from an attached end of the depressible portion.

Other aspects of the invention will become apparent by consideration of the detailed description and accompanying drawings.

### BRIEF DESCRIPTION OF THE DRAWINGS

FIG. 1 is a perspective view of a deadbolt assembly with a first backset dimension and the bolt retracted according to a first embodiment;

FIG. 2 is a perspective view of a deadbolt assembly with the first backset dimension and the bolt extended according to the first embodiment;

FIG. 3 is a perspective view of a deadbolt assembly with a second backset dimension and the bolt retracted according to the first embodiment;

FIG. 4 is a perspective view of a deadbolt assembly with the second backset dimension and the bolt extended according to the first embodiment;

FIG. 5 is an exploded assembly view of the assembly according to the first embodiment;

FIG. 6 is a reverse exploded assembly view of the assembly according to the first embodiment;

FIG. 7 is a section view taken along line A-A of FIG. 1;

FIG. 8 is a section view taken along line C-C of FIG. 2;

FIG. 9 is a section view taken along line A′-A′ of FIG. 3;

FIG. 10 is a section view taken along line C′-C′ of FIG. 4;

FIG. 11 is a section view taken along line B-B of FIG. 1;

FIG. 12 is a section view taken along line B′-B′ of FIG. 3;

FIG. 13 is a section view taken along line D-D of FIG. 2;

FIG. 14 is a section view taken along line D′-D′ of FIG. 4;

FIG. 15 is a perspective view of a deadbolt assembly with a first backset dimension and the bolt retracted according to a second embodiment;

FIG. 16 is a perspective view of a deadbolt assembly with a first backset dimension and the bolt extended according to the second embodiment;

FIG. 17 is a perspective view of a deadbolt assembly with a second backset dimension and the bolt retracted according to the second embodiment;

FIG. 18 is a perspective view of a deadbolt assembly with the second backset dimension and the bolt extended according to the second embodiment;

FIG. 19 is an exploded assembly view of the assembly according to the second embodiment;

FIG. 20 is a reverse exploded assembly view of the assembly according to the second embodiment;

FIG. 21 is a section view taken along line E-E of FIG. 15;

FIG. 22 is a section view taken along line G-G of FIG. 16;

FIG. 23 is a section view taken along line E′-E′ of FIG. 17;

FIG. 24 is a section view taken along line G′-G′ of FIG. 18;

FIG. 25 is a section view taken along line F-F of FIG. 15;

FIG. 26 is a section view taken along line F′-F′ of FIG. 17;

FIG. 27 is a section view taken along line H-H of FIG. 16;

FIG. 28 is a section view taken along line H′-H′ of FIG. 18;

FIG. 29 is a perspective view of a cam/bolt housing of a third embodiment; and

FIG. 30 is a perspective view of a cam/bolt housing of a fourth embodiment.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

A lockset adaptable for different backset dimensions is disclosed by Schlage Lock Company in U.S. Pat. No. 5,152,558, which is hereby incorporated in its entirety by reference. The invention described in detail herein is intended to provide additional benefits to an adjustable deadbolt assembly.

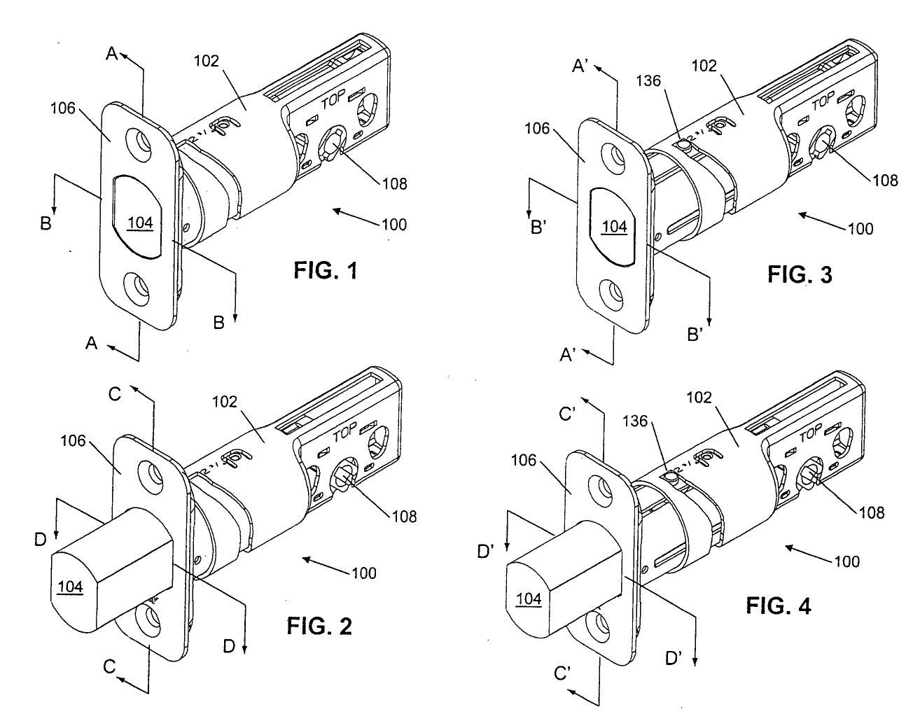

FIGS. 1-14 illustrate views of a deadbolt assembly 100 according to one embodiment of the invention. The deadbolt assembly 100 includes a housing 102, a bolt 104, and a faceplate 106. The housing 102 receives a cam 108, for operation of the bolt 104 along a bolt axis 109 (i.e., central axis) as described in greater detail below. The housing 102 is configured to be positioned within a door (not shown). The faceplate 106 can be installed on an edge of the door between two opposite faces of the door. The faceplate includes an aperture 110 configured to allow passage of the bolt 104 therethrough.

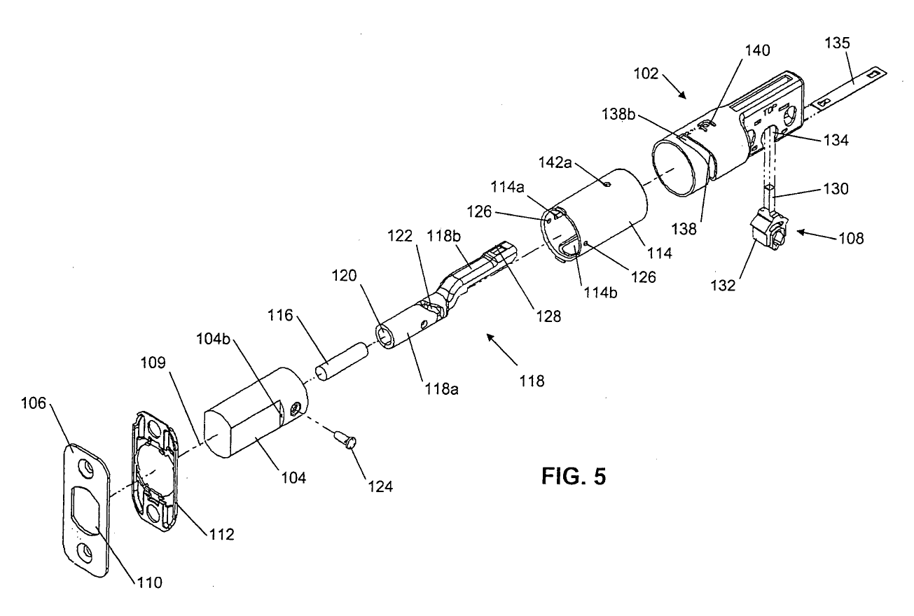

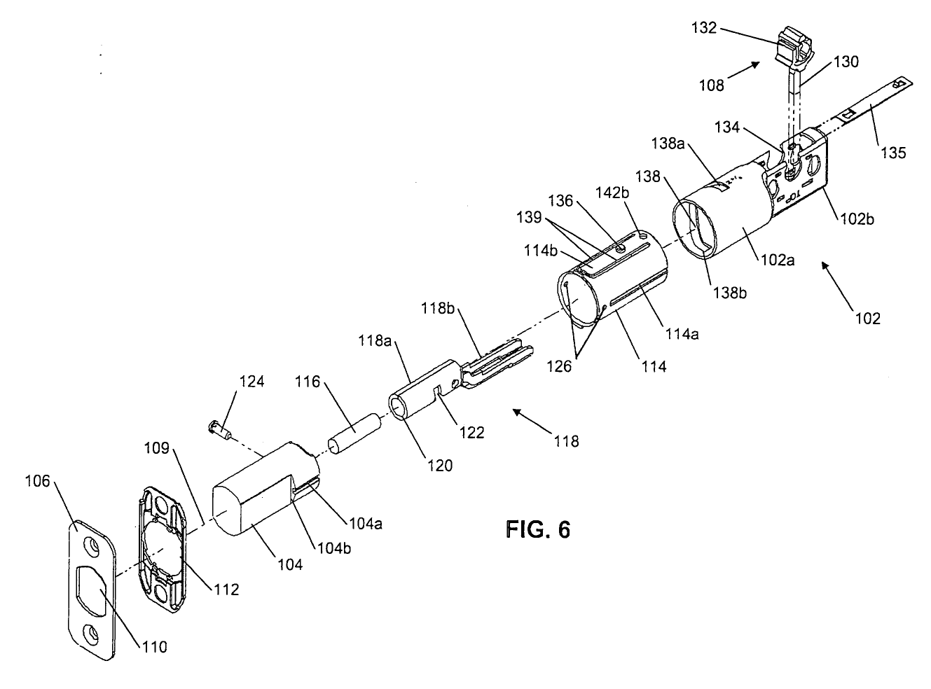

FIG. 5 illustrates an exploded assembly view showing all the components of the deadbolt assembly 100. FIG. 6 illustrates an exploded assembly view looking from an opposite angle. The end at which the faceplate 106 resides is referred to herein as the “front” wherein the “back” or “rear” relates to the end of the assembly 100 opposite the faceplate 106. The faceplate 106 can be provided with a backing plate 112, which mates with the faceplate 106. In some embodiments, the backing plate 112 is eliminated and such features as are present in the backing plate 112 can be incorporated into the faceplate 106 or eliminated altogether. The bolt 104 fits within an inner bolt housing 114, which is positioned adjacent the faceplate 106. The bolt 104 includes at least one slot 104a, which engagingly receives a rib 114a positioned on an inner diameter portion of the inner bolt housing 114. The engagement of the rib 114a and the slot 104a inhibit the inner bolt housing 114 and the bolt 104 from rotating about the axis 109 relative to each other. Both the rib 114a and the slot 104a are illustrated being formed parallel to the bolt axis 109, but other arrangements may be used for engaging the bolt 104 and the inner bolt housing 114.

With continued reference to FIGS. 5 and 6, an anti-saw rod 116 is positioned at the back side of the bolt 104 to provide security through resistance to sawing, such as by a reciprocating saw or the like. The anti-saw rod 116 can resist being cut by spinning in place when engaged by a blade and/or by being constructed of a hardened steel or another material resistant to sawing. The bolt bar 118 extends from the bolt 104 back into the housing 102 where it is coupled to the cam 108. The bolt bar 118 is provided with a front portion 118a and a rear portion 118b. The front portion 118a is generally cylindrical with an aperture 120 to receive the anti-saw rod 116. Also provided in the front portion 118a is a slot 122, which receives a portion of a bolt connector 124. The bolt connector 124 is fixed to the bolt 104 and is slidably received in the slot 122 to adjust the backset as described in greater detail below. The bolt connector 124 can be a fastener, a pin, an integral protrusion, etc., which provides a coupling between the bolt 104 and the bolt bar 118 such that the bolt 104 is movable along the axis 109 with the bolt bar 118 as the bolt bar 118 is actuated. The bolt 104 is thereby movable between an extended position and a retracted position as discussed in greater detail below. At the extended position, the bolt 104 can be inhibited from further extension by the stops 104b, which abut dimples 126 formed in the inner bolt housing 114. In an alternate embodiment, the assembly 100 may not require the dimples 126, and instead relies on any of the faceplate 106, the backing plate 112, and the interface between the actuator 130 of the cam 108 and the engaging portion 128 of the bolt bar 118 to limit the extension of the bolt 104.

The rear portion 118b of the bolt bar 118 is provided with an engaging portion 128, which is engageable with an actuator 130 of the cam 108. The engaging portion 128 is illustrated as a rectangular aperture through the rear portion 118b, which receives the cam actuator 130. However, the rear portion 118b can be provided with any one of a various assortment of cam following structures to enable the bolt bar 118 (and thus, the bolt 104) to be cammed between extended and retracted positions. The cam 108 includes a cam body 132, which is held in a recess 134 of the housing 102. The cam 108 is rotatable about a fixed axis defined by the recess 134 to enable camming of the bolt bar 118 to actuate the bolt 104 to move from the retracted position to the extended position or vice versa. FIGS. 2, 4, 8, 10, 13 and 14 illustrate the bolt 104 in the extended position, and FIGS. 1, 3, 7, 9, 11, and 12 illustrate the bolt 104 in the retracted position. A spring plate 135 is positioned at a rear portion 102b of the housing 102 to provide an upward bias to the cam 108. The spring plate 135 can assist in positively placing the cam 108 in either one of its limit positions, which correspond to the extended and retracted positions of the bolt 104.

Returning to FIGS. 5 and 6, the inner bolt housing 114 is generally cylindrical and is positioned within a front portion 102a of the housing 102 during operation. The inner bolt housing 114 is provided with a protrusion 136 on an outer wall thereof for engaging a slot 138 in the housing 102. The protrusion 136 is located on a depressible portion such as a depressible snap finger 114b, which can be defined by an elongated “U-shape” groove 139 cut into the inner bolt housing 114. The depressible snap finger 114b is elastically deformable such that it is movable relative to the remainder of the inner bolt housing 114 under sufficient load. The spring behavior of the depressible snap finger 114b allows the inner bolt housing 114 to be inserted into the housing 102 during assembly. The depressible snap finger 114b can be deflected (the protrusion 136 being deflected with it), allowing the inner bolt housing 114 to be inserted into the housing 102 until the protrusion 136 is aligned with any part of the slot 138 in the housing 102. Once inserted, the depressible snap finger 114b can substantially spring back to its original shape and position, positioning the protrusion 136 in the slot 138. The inner bolt housing 114 is thereby rotatably engaged with the housing 102 in order to allow the adjustment for different backset dimensions as described in greater detail below. In some embodiments, once assembled in the inner bolt housing 114, the bolt 104 blocks the depressible snap finger 114b from significant inward deflection to prevent inadvertent separation. The bolt 104 remains in contact with or directly inward of the depressible snap finger 114b in the retracted position, the extended position, and throughout adjustment between the two positions. This inhibits the protrusion 136 from escaping the slot 138.

In some embodiments, the housing 102 and the inner bolt housing 114 are reversed such that the inner bolt housing 114 encompasses the housing 102 within it. In some embodiments, the protrusion 136 and the slot 138 are reversed such that the protrusion 136 is located on the housing 102 and the slot 138 is located in the inner bolt housing 114. In some embodiments, both the inner/outer orientation and the protrusion 136 and slot 138 are reversed. In such embodiments, a depressible portion may be provided on the housing 102 to allow deflection of the protrusion 136 radially inwardly. The depressible portion allows the housing 102 to be inserted into the inner bolt housing 114 such that the protrusion 136 engages the slot 138. Further adaptations obvious to those skilled in the art can allow the assembly 100 to function in accordance with objectives of the invention as described throughout.

With continued reference to the figures, the protrusion 136 is engaged with the slot 138 when the inner bolt housing 114 is assembled within the housing 102. The slot 138 is generally helically disposed in the housing 102 such that the slot includes a first end 138a and a second end 138b, which are spaced a distance apart along an axis parallel to the bolt axis 109. The distance is generally equivalent to the difference between two predetermined backset dimensions. In some embodiments, the distance is about ⅜ inches. In some embodiments, when the protrusion 136 is positioned at or near the first end 138a, the backset dimension can be set at a value of about 2⅜ inches. When the protrusion 136 is positioned at or near the second end 138b, the backset dimension can be set at a value of about 2¾ inches. The adjustment of the deadbolt assembly 100 between backset dimensions is described in further detail below.

When adjusting the backset dimension, some components maintain a fixed orientation while other components are rotated about the bolt axis 109. To adjust the backset dimension, a user may grasp the faceplate 106 and/or the bolt 104 and twist. The bolt 104 will rotate about the bolt bar 118, as the bolt connector 124 travels generally helically along the slot 122. Because the bolt 104 and the inner bolt housing 114 are fixed against relative rotation by the rib 114a and slot 104a, the inner bolt housing 114 rotates with the bolt 104 through a common angle about the bolt axis 109. The common angle may be approximately 180 degrees in the illustrated embodiment. The housing 102 may remain fixed along with the bolt bar 118 and cam 108 during backset adjustment while the protrusion 136 moves along the slot 138. Such an adjustment may be made by rotating the faceplate 106 and/or bolt 104 while the rear end of the assembly (i.e., the housing 102 and the cam 108) is mounted in the door and assembled with additional hardware, which allows user operation of the bolt position. The slots 122 and 138 need not be shaped as a perfect helix, but instead, can be comprised of a combination of curved, straight, and angled portions to achieve an overall axial displacement by rotation of the bolt 104 about the bolt axis 109. Further embodiments are described in greater detail below.

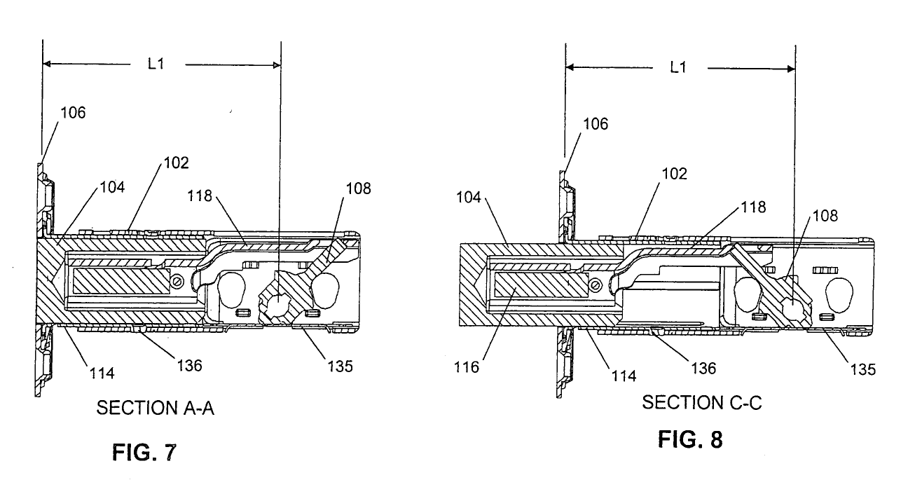

As discussed above, it may be desirable to provide the ends 138a and 138b of the slot 138 in the housing 102 as limit positions for the protrusion 136. This limits the rotation of the inner bolt housing 114 and the bolt 104 in either direction. To provide tactile and/or audible feedback to the operator adjusting the backset dimension and to assist in maintaining the assembly 100 in one of the two predetermined backset positions, a detent 140 is provided on the upper side of the housing 102. The detent 140 can be located on a deflectable member, which allows a small amount of elastic deflection. In some embodiments, the deflectable member is defined by a groove or a cutout, such as a “U” shaped cutout, which allows the deflectable member to be deflected relative to the housing 102 under a predetermined amount of force. The detent 140 is engageable with one of two holes 142a and 142b, which are positioned on the inner bolt housing 114 and spaced about 180 degrees from each other. When the protrusion 136 is located adjacent the slot end 138a (corresponding to a first, shorter backset dimension), the detent 140 engages the hole 142a. When the protrusion 136 is located adjacent the slot end 138b (corresponding to a second, longer backset dimension), the detent 140 engages the hole 142b. The backset dimensions are discussed further below and illustrated in FIGS. 7-14.

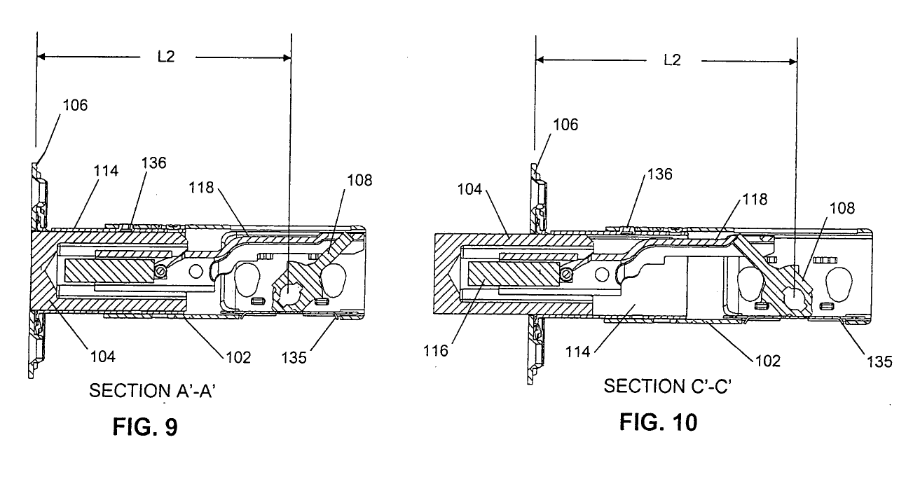

Comparing FIG. 1 and FIG. 3 illustrates the difference in backset adjustment while the bolt 104 is in the retracted state. Likewise, FIG. 2 and FIG. 4 illustrate the difference in backset adjustment while the bolt 104 is extended. Several cross-sections are also illustrated to show the arrangement of components within the deadbolt assembly 100 during the various combinations of bolt position and backset dimension. FIG. 7 is a section view taken along line A-A of FIG. 1. FIG. 8 is a section view taken along line C-C of FIG. 2. FIGS. 7 and 8 illustrate the bolt 104 being actuated between the retracted and extended positions, respectively. The backset is equal to the first, shorter backset dimension (referred to hereinafter as L1) in both FIG. 7 and FIG. 8. FIG. 9 is a section view taken along line A′-A′ of FIG. 3. FIG. 10 is a section view taken along line C′-C′ of FIG. 4. FIGS. 9 and 10 illustrate the bolt 104 being actuated between the retracted and extended positions, respectively. The backset is equal to the second, longer backset dimension (referred to hereinafter as L2) in both FIG. 9 and FIG. 10.

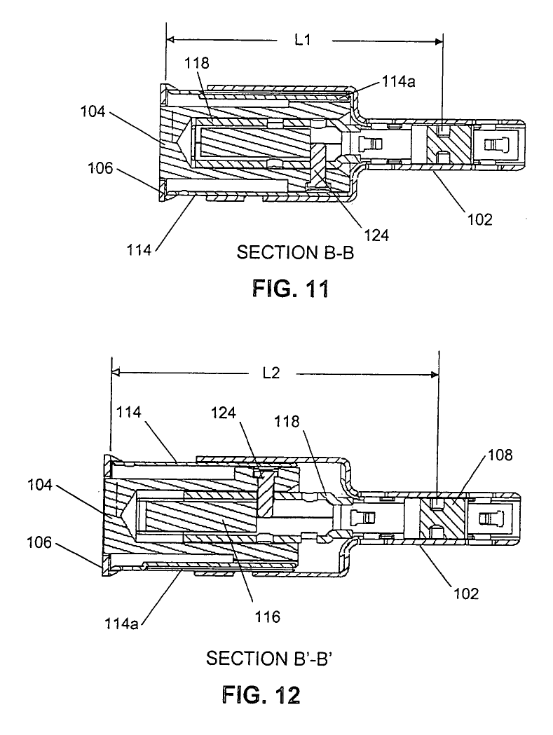

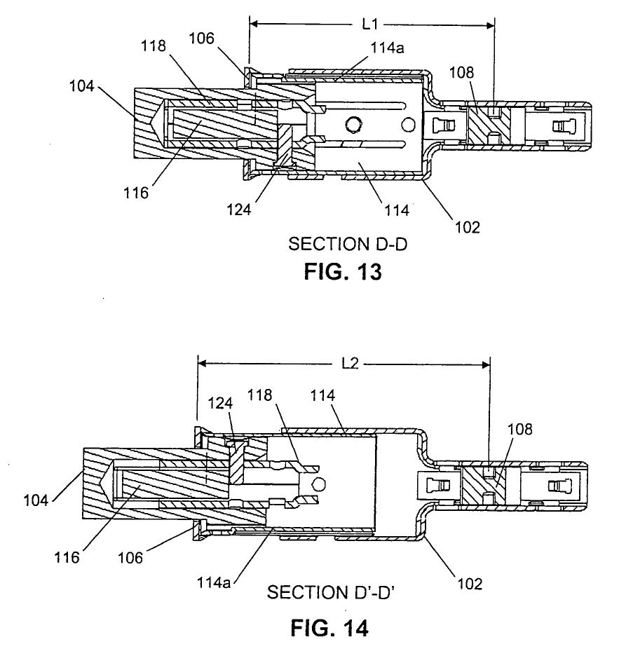

FIG. 11 is a section view taken along line B-B of FIG. 1. FIG. 12 is a section view taken along line B′-B′ of FIG. 3. FIGS. 11 and 12 illustrate the deadbolt assembly 100 being adjusted between the L1 backset and the L2 backset, respectively. The bolt 104 is retracted in both FIG. 11 and FIG. 12. FIG. 13 is a section view taken along line D-D of FIG. 2. FIG. 14 is a section view taken along line D′-D′ of FIG. 4. FIGS. 13 and 14 illustrate the deadbolt assembly 100 being adjusted between the L1 backset and the L2 backset, respectively. The bolt 104 is extended in both FIG. 13 and FIG. 14.

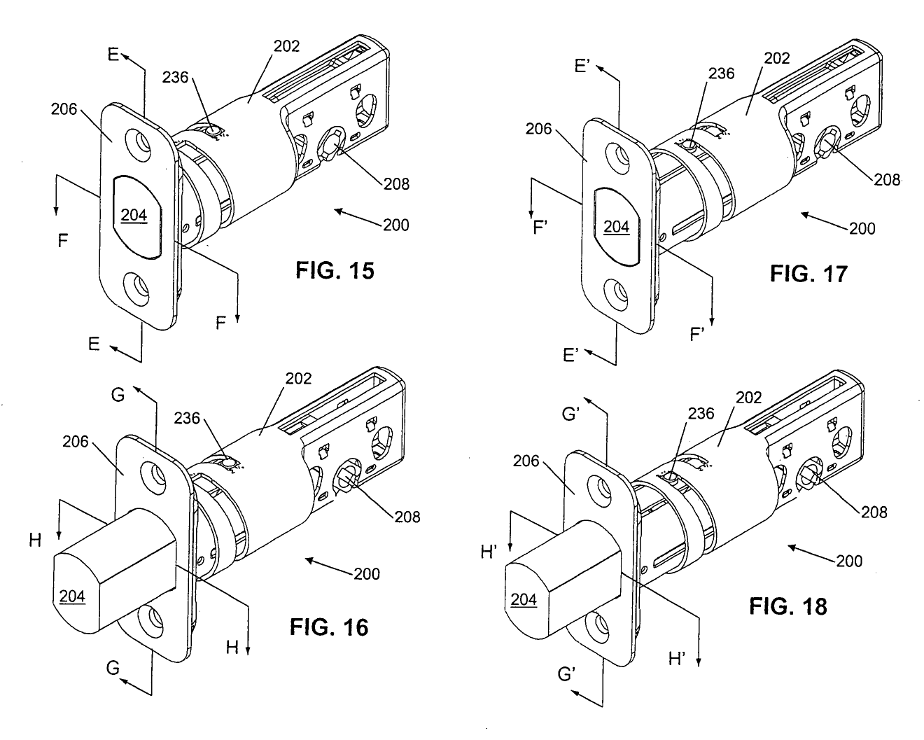

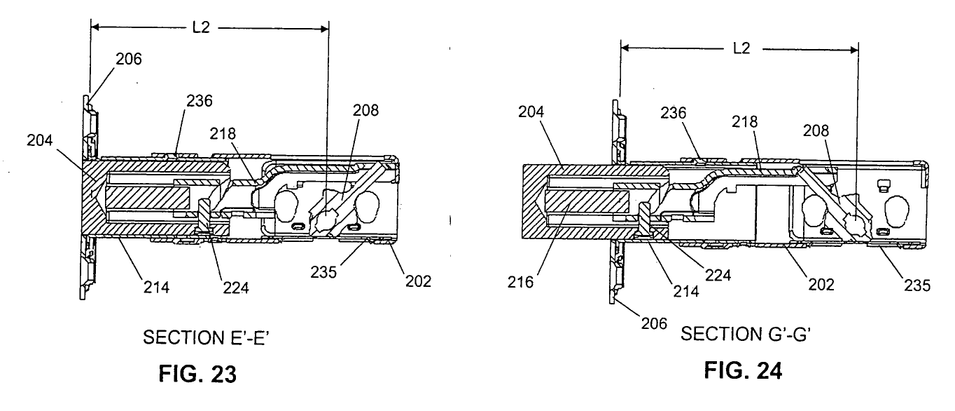

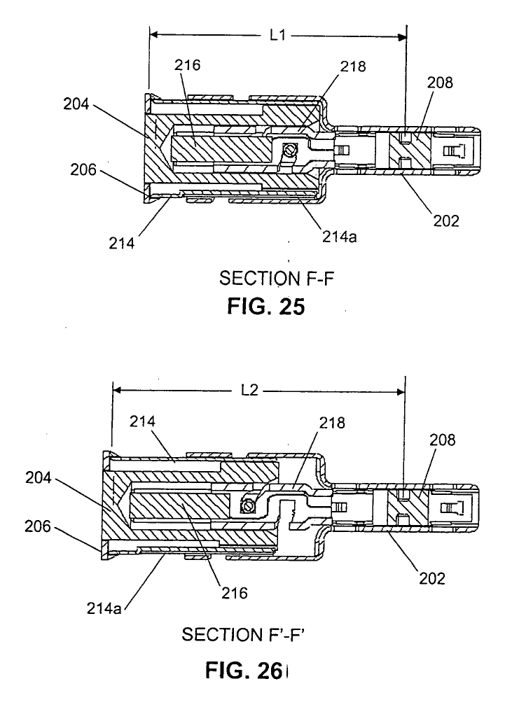

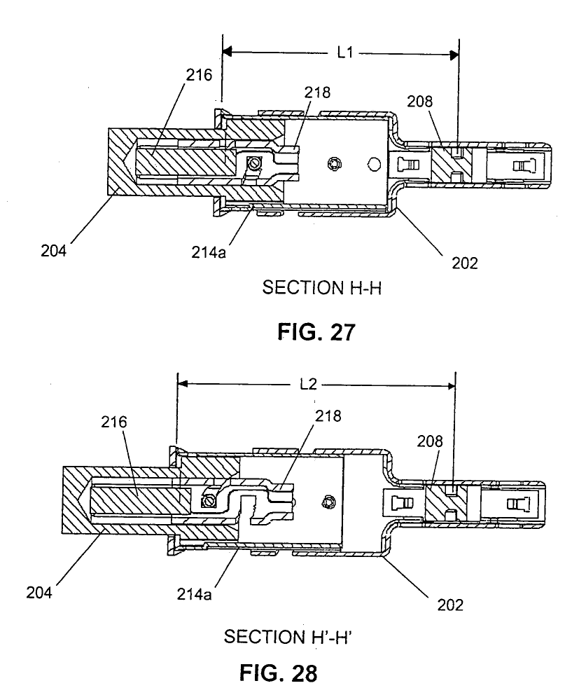

A deadbolt assembly 200 according to a second embodiment is illustrated in FIGS. 15-28. The deadbolt assembly allows for backset dimension adjustability and is constructed with the same general form as the first embodiment. As such, like reference numbers (in the 200's) are assigned to like parts.

The difference between the first embodiment and the second embodiment is that the deadbolt assembly 200 of the second embodiment allows for adjustment of the backset dimension between predetermined values L1 and L2 by a rotation about the bolt axis 209 of about 360 degrees. As such, the housing 202 is provided with a slot 238, which is generally helical and includes a first end 238a and a second end 238b that lies substantially adjacent to the first end 238a. The first end 238a and the second end 238b can be positioned on the top portion of the housing 202 and can be spaced apart along an axis parallel to the bolt axis 209 by a distance equivalent to the difference between the two backset dimensions L1 and L2. In some embodiments, the difference between L1 and L2 is about ⅜ inches.

FIGS. 15-18 illustrate the various combinations of bolt position (extended or retracted) and backset adjustment from perspective views. As illustrated, the protrusion 236 of the inner bolt housing 214 is positioned at the top of the assembly 200 in either of the two predetermined backset adjustment positions. Similar to the first embodiment, rotation of the cam 208 actuates the bolt 204 between the extended and retracted positions.

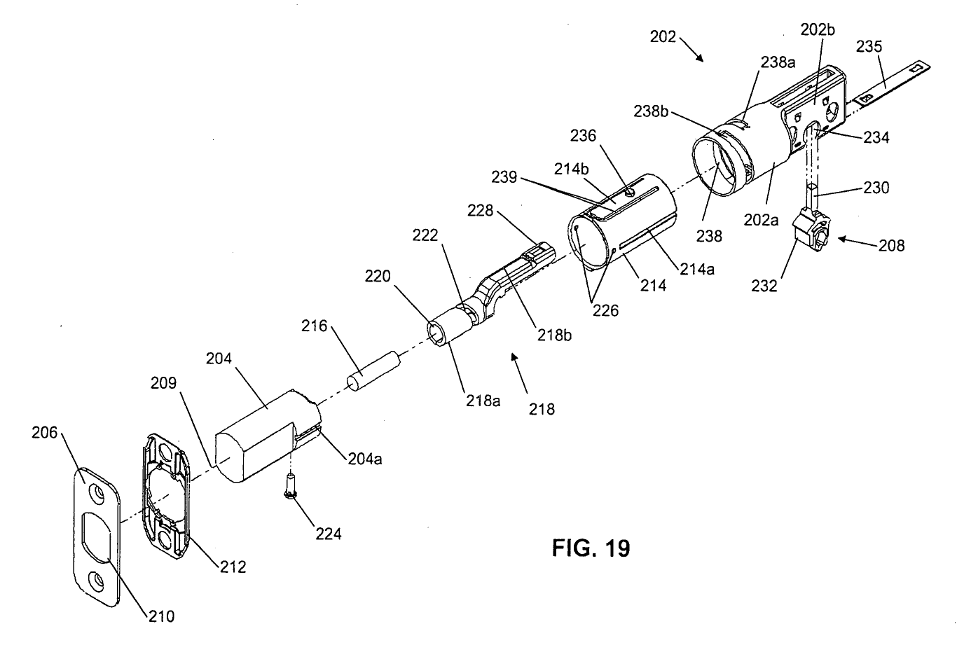

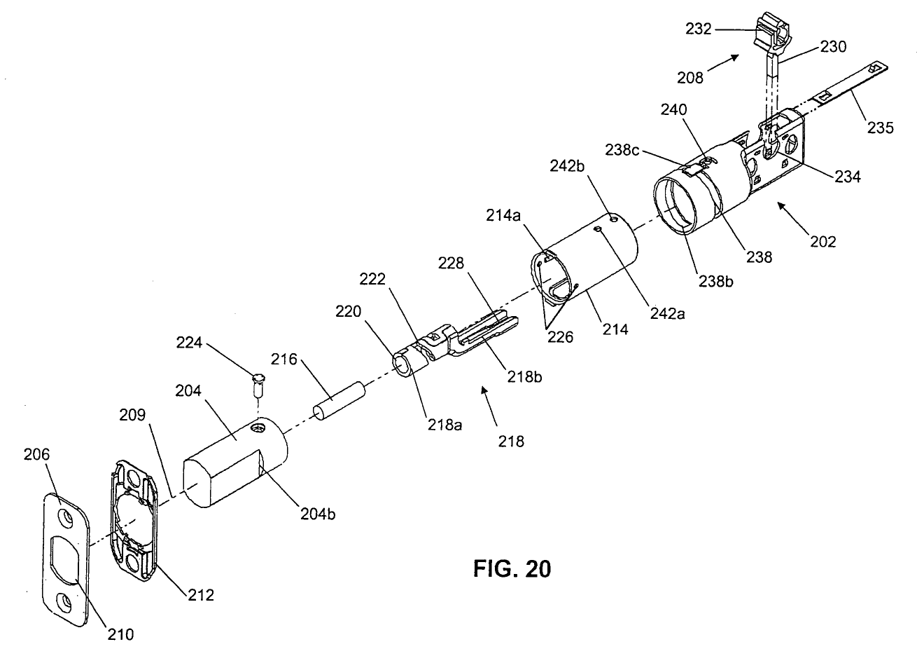

FIGS. 19 and 20 illustrate exploded assembly views from two opposing perspectives. The bolt 204 is illustrated with a bolt connector 224, which attaches in the vertical direction. This allows the bolt connector 224 to couple the bolt 204 to the bolt bar 218 via the slot 222 in the bolt bar 218, which is positioned in generally the same orientation and shape as the slot 238 in the housing 202. The bolt connector 224 need not be located in the orientation as illustrated, as long as it is configured to engage properly with the slot 222 in the bolt bar 218, which similarly may be reoriented in alternate embodiments. As noted above, the slots 222 and 238 need not be perfectly helical, but allow an extension or retraction between the housing 202 and the inner bolt housing 214 by relative rotation about the bolt axis 209 to adjust the backset. With reference to FIG. 20, the middle portion of the slot 238 is provided with a reinforcement portion 238c, which strengthens the housing 202 at that location. The reinforcement portion 238c can be a tab or bridge, which is formed integrally or otherwise coupled to the housing 202 to inhibit deformation of the slot 238 and the housing 202 while allowing the protrusion 236 to pass through from the first end 238a to the second end 238b and vice versa.

The detent 240 is positioned at the bottom of the housing 202 adjacent the reinforcement portion 238c. The first and second holes 242a and 242b are positioned substantially opposite the protrusion 236 on the inner bolt housing 214 for selective engagement with the detent 240. When the protrusion 236 is positioned adjacent the first end 238a of the slot 238, the detent 240 can engage the first hole 242a and provide a snapping feature indicating that the assembly 200 is set in the first backset dimension L1. When the protrusion 236 is positioned adjacent the second end 238b of the slot 238, the detent 240 can engage the second hole 242b and provide a snapping feature indicating that the assembly 200 is set in the second backset dimension L2. The detent 240 and holes 242a and 242b can also assist in maintaining the assembly in one of the two predetermined backset positions.

With the deadbolt assembly 200 having a 360 degree backset adjustment angle, every component in the assembly 200 maintains a single orientation, whether the backset dimension is set to the first dimension L1 or the second dimension L2. The only positioning that differs when comparing component placement in the L1 backset to the L2 backset is axial shift. The common orientation of parts provides the user with a choice of rotating the front end or the back end to change the backset dimension. For example, the faceplate 206 and bolt 204 can remain fixed in the door while the housing 202 (and along with it the cam 208 and bolt bar 218) is rotated 360 degrees to adjust the backset dimension. This provides an installer with a choice of which end to adjust, should he or she partially install the deadbolt assembly 200 with the incorrect backset dimension. This may save the user time in adjusting the backset.

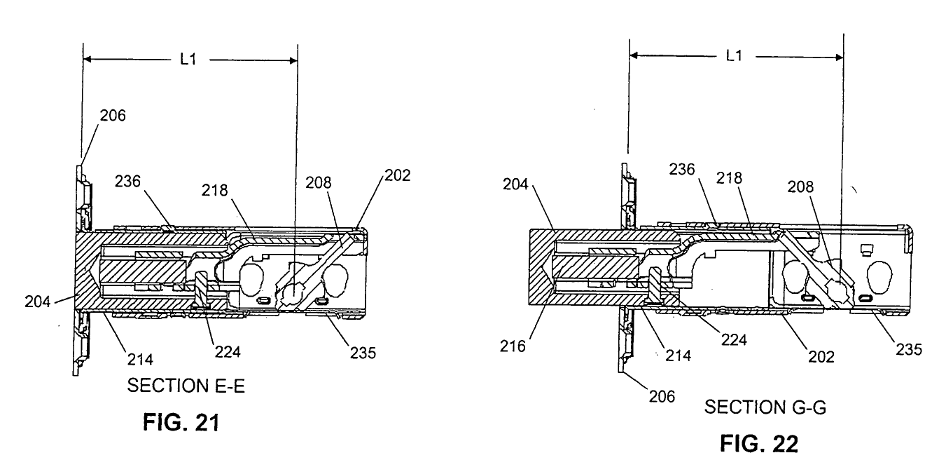

FIGS. 21-28 illustrate further views of the second embodiment, similar to the views provided of the first embodiment. The figures contain various cross-sectional views, which illustrate the deadbolt assembly 200 in various states. From the figures and the preceding description, the operation of the bolt 204 and the adjustment of the backset dimension are apparent to those of ordinary skill in the art.

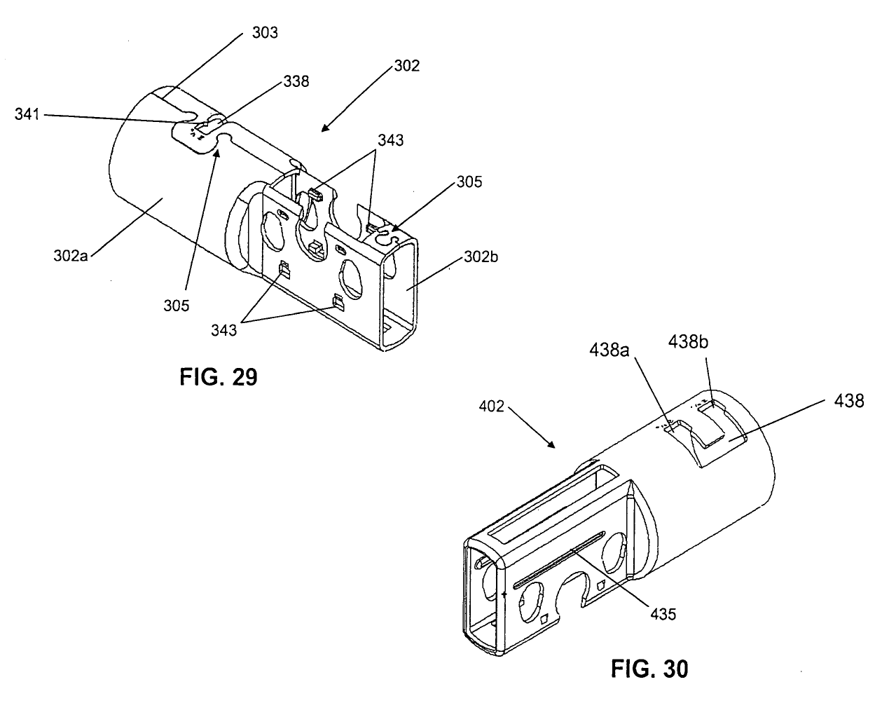

As shown in FIGS. 1-28, the housing 102, 202 is provided as a one-piece component, which serves to integrally form a bolt housing and a cam housing. The round front portion 102a, 202a of the housing 102, 202 houses the bolt 104, 204 and the inner bolt housing 114, 214. The rear rectangular portion 102b, 202b of the housing 102, 202 houses the cam 108, 208. The bolt bar 118, 218 is movable between the front and rear portions of the housing 102, 202. The housing 102, 202 can be formed as a seamless deep-drawn metal part, but can also take on various other constructions. The housing 102, 202 may be manufactured using a number of processes including, but not limited to, transfer die, progressive die, machining, metal injection molding, and die cast. By forming the housing 102, 202 as a single part that houses the cam 108, 208, the bolt 104, 204, and the bolt bar 118, 218, the assembly component count is reduced as is the assembly time and required effort. Additionally, because there are fewer connections between parts, the structural integrity of the assembly 100, 200 is improved. This eliminates weak points, which often occur at connection locations. In one embodiment, a housing 302 is formed as a rolled, one-piece component as illustrated in FIG. 29. The housing 302 features a longitudinal seam 303, which can be locked with locking fingers 305 in at least one location. The housing 302 is illustrated with a slot 338 of about 180 degrees helically disposed in a front portion 302a. At the ends of the slot 338, detents 341 are positioned to engage a protrusion (not shown) that may be on the bolt or inner bolt housing. The detents 341 can keep the protrusion in place and provide tactile and audible feedback to alert the user of proper positioning of the assembly into one of the predetermined backset positions. Piercings 343 are provided in a rear portion 302b of the housing 302 to limit the rotation of the cam (not shown) and guide and/or limit the movement of the bolt bar (not shown).

FIG. 30 illustrates a housing 402 similar in many aspects to the housings 102, 202, and 302 described above with a slot 438 of an alternative configuration. The housing 402 includes a guide rib 435 to guide a bolt bar. In some embodiments, the slot 438 and the slot in the bolt bar are provided as substantially serpentine pathways. In some embodiments, the slots need not be helically disposed at all, but rather, are each shaped as a “U”, “V”, or “C”, providing two ends which define limit positions to set the backset dimension. The housing 402 includes a serpentine “U” slot 438 with a first end 438a and a second end 438b. Any slot shape that provides at least two positions spaced a distance apart along the bolt axis can be used to define the orientation of components in the predetermined backset dimensions. In some embodiments, this requires a net rotation between parts, such as the helical rotation between the bolt and the housing as described above with reference to other embodiments. In further embodiments, such as the housing 402, a net rotation of zero degrees can be used to adjust the backset dimension. In such an embodiment, the bolt can be rotated relative to the housing 402 through a first positive angle and then slid along the bolt axis (without moving relative to the inner bolt housing or the faceplate) before being rotated a second negative angle, equal in magnitude to the first angle. In further embodiments, it is possible to eliminate the need for any rotation whatsoever by providing telescoping motion between the bolt and the housing separate from the cam-actuated extension and retraction movement.

Thus, the invention provides, among other things, an improved adjustable backset deadbolt assembly. Various features and advantages of the invention are set forth in the following claims.

What is claimed is:

1. An adjustable backset deadbolt assembly including a bolt extendable to an extended position and retractable to a retracted position along a bolt axis in response to movement of a cam and a bolt bar comprising:
an outer housing including a slot; and
an inner housing fixed against rotation relative to the bolt and including a protrusion extending radially from a depressible portion of the inner housing and positioned to engage the slot to enable adjustment of a backset dimension.

2. The adjustable backset deadbolt assembly of claim 1, wherein the depressible portion is formed in the inner housing by a groove cut into a wall thereof.

3. The adjustable backset deadbolt assembly of claim 2, wherein the groove is substantially U-shaped.

4. The adjustable backset deadbolt assembly of claim 2, wherein the groove is cut through the entire wall thickness of the inner housing.

5. The adjustable backset deadbolt assembly of claim 1, wherein the protrusion is positioned about one third the length of the depressible portion away from an attached end of the depressible portion.

6. The adjustable backset deadbolt assembly of claim 1, wherein the inner housing and the bolt are movable together relative to the outer housing to adjust the backset dimension of the deadbolt assembly.

7. The adjustable backset deadbolt assembly of claim 6, wherein the inner housing and the bolt are rotatable through an angle of about 180 degrees about the bolt axis to adjust the backset dimension from a first predetermined value to a second predetermined value.

8. The adjustable backset deadbolt assembly of claim 6, wherein the inner housing and the bolt are rotatable through a net angle of about zero degrees about the bolt axis to adjust the backset dimension from a first predetermined value to a second predetermined value.

9. The adjustable backset deadbolt assembly of claim 1, wherein a bolt connector is fixed to the bolt and insertable into a slot in the bolt bar, the bolt being movable relative to the bolt bar to adjust a backset dimension between a first predetermined value and a second predetermined value.

10. The adjustable backset deadbolt assembly of claim 1, wherein upon assembly of the bolt within the inner housing, the depressible portion is blocked from being depressed to maintain the protrusion engaged in the slot.

11. The adjustable backset deadbolt assembly of claim 10, wherein the bolt blocks the depressible portion throughout the movement of the bolt between the extended and retracted positions.

12. An adjustable backset deadbolt assembly including a bolt extendable to an extended position and retractable to a retracted position along a bolt axis in response to movement of a cam and a bolt bar comprising:
a first housing; and
a second housing, wherein one of the first housing and the second housing includes a slot and the other of the first housing and the second housing includes a protrusion extending from a depressible portion, the depressible portion being depressible to enable insertion of the protrusion into the slot, a backset dimension being adjustable by movement of the protrusion in the slot.

13. The adjustable backset deadbolt assembly of claim 12, wherein the first housing is positioned within the second housing and is fixed against relative rotation with respect to the bolt, the first housing including the depressible portion and the protrusion extending therefrom.

14. The adjustable backset deadbolt assembly of claim 13, wherein the depressible portion is formed in the first housing by a groove cut into a wall thereof.

15. The adjustable backset deadbolt assembly of claim 14, wherein the groove is substantially U-shaped.

16. The adjustable backset deadbolt assembly of claim 14, wherein the groove is cut through the entire wall thickness of the inner housing.

17. The adjustable backset deadbolt assembly of claim 13, wherein the first housing and the bolt are rotatable through an angle of about 180 degrees about the bolt axis relative to the second housing to adjust the backset dimension from a first predetermined value to a second predetermined value.

18. The adjustable backset deadbolt assembly of claim 13, wherein the first housing and the bolt are rotatable through a net angle of about zero degrees about the bolt axis relative to the second housing to adjust the backset dimension from a first predetermined value to a second predetermined value.

19. The adjustable backset deadbolt assembly of claim 13, wherein upon assembly of the bolt within the first housing, the depressible portion is blocked from being depressed to maintain the protrusion engaged in the slot.

20. The adjustable backset deadbolt assembly of claim 19, wherein the bolt blocks the depressible portion throughout the movement of the bolt between the extended and retracted positions.

21. The adjustable backset deadbolt assembly of claim 12, wherein a bolt connector is fixed to the bolt and insertable into a slot in the bolt bar, the bolt being movable relative to the bolt bar to adjust the backset dimension between a first predetermined value and a second predetermined value.

22. The adjustable backset deadbolt assembly of claim 12, wherein the protrusion is positioned about one third the length of the depressible portion away from an attached end of the depressible portion.

23. An adjustable backset deadbolt assembly including a bolt extendable and retractable along a bolt axis in response to movement of a cam and a bolt bar, the bolt having a connector engageable with a slot in the bolt bar to enable the bolt to be rotatable relative to the bolt bar to adjust a backset dimension between a first predetermined value and a second predetermined value comprising:
an outer housing including a slot; and
an inner housing fixed against rotation relative to the bolt and including a protrusion extending radially from a depressible portion of the inner housing and positioned to engage the slot to enable adjustment of the backset dimension,
wherein the depressible portion is formed by a U-shaped groove cut through an entire wall thickness of the inner housing and the protrusion is positioned about one third the length of the depressible portion away from an attached end of the depressible portion.
